(19) United States
(12) Patent Application Publication
(10) Pub. No.: US 2010/0149683 A1
(43) Pub. Date: Jun. 17, 2010

(54) MAGNETIC DISK DRIVE AND WRITE OFFSET CORRECTION METHOD THEREIN

(75) Inventor: Michinaga Yamagishi, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Toshiba Storage Device Corporation, Tokyo (JP)

(21) Appl. No.: 12/709,351

(22) Filed: Feb. 19, 2010

Related U.S. Application Data
(63) Continuation of application No. PCT/JP2007/000888, filed on Aug. 20, 2007.

(51) Int. Cl. G11B 5/596

(52) U.S. Cl. 360/77.02; G9B/5.216

(57) ABSTRACT

According to one embodiment, a magnetic disk drive uses a patterned medium on which data tracks having a recording layer and grooves having no recording layer as a disk. The magnetic disk drive includes a correction unit which corrects the head center position of a write head so that a head edge portion on the side to which the top edge of the write head is tilted falls within or substantially falls within a groove on the side to which the top edge of the write head is tilted.

### CROSS REFERENCE TO RELATED APPLICATIONS

This is a Continuation Application of PCT Application No. PCT/JP2007/000888, filed Aug. 20, 2007, which was published under PCT Article 21(2) in Japanese.

### BACKGROUND

1. Field

One embodiment of the present invention relates to a write offset correction technique in a magnetic disk drive.

2. Description of the Related Art

A magnetic disk drive using a patterned medium on which data tracks (land portions having a recording layer) and grooves (portions having no recording layer) are alternately arranged in the radial direction of a disk is available.

In such magnetic disk drive, a head edge portion may often protrude to groove regions on the two ends of a track depending on the magnitude relationship between a track width and write core width. The head edge portion has a side to which it is allowed to protrude and that to which it is inhibited from sticking out in terms of data quality assurance.

This point will be described below with reference to FIG. 9.

In FIG. 9, each trapezoid represents a head shape, and also a magnetic record for one bit corresponding to “0” or “1”. A broken line 1001 indicates a head edge portion which is located on the side to which a head tilts its top edge. On this side, the magnetic records of respective bits are densely stuck in a narrow region. For this reason, this head edge portion is recognized as noise when it is read.

A broken line 1002 indicates a head edge portion located on the side opposite to the side to which the head tilts its top edge. On this side, the magnetic records of respective bits are arranged to have a margin compared to the head edge position on the opposite side. This side is not recognized as noise when it is read. On the other hand, when the side of this broken line 1002 sticks out to a groove, since the opposite side (that of the broken line 1001) is located on a data track, the data quality deteriorates.

Note that patent reference 1 discloses a technique which sets a write offset margin as an allowable offset upon data writing to be an optimal value in a normal disk drive which does not use a patterned medium.

Patent Reference 1: Japanese Patent Laid-Open No. 8-293174 “Allowable off-track amount setting method and apparatus, and disk drive”

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a view showing write head offset correction according to the first embodiment of the present invention;

FIG. 2 is a block diagram showing the arrangement of a magnetic disk drive according to the first embodiment of the present invention;

FIG. 3 is a view showing a conventional method of calculating a write offset position of a target track from a write offset position of a reference track and respective track pitches;

FIG. 4 is a view showing a method of calculating a write offset position of a target track from a write offset position of a reference track and respective track pitches according to the second embodiment of the present invention;

FIG. 5 is a block diagram showing the arrangement of a magnetic disk drive according to the second embodiment of the present invention;

FIG. 6 is a view showing a track profile of a signal-to-noise ratio (SNR);

FIG. 7 is a block diagram showing the arrangement of a magnetic disk drive according to the third embodiment of the present invention;

FIG. 8 is a block diagram showing the arrangement of a magnetic disk drive according to the fourth embodiment of the present invention; and

FIG. 9 is a view showing the problems of the background art.

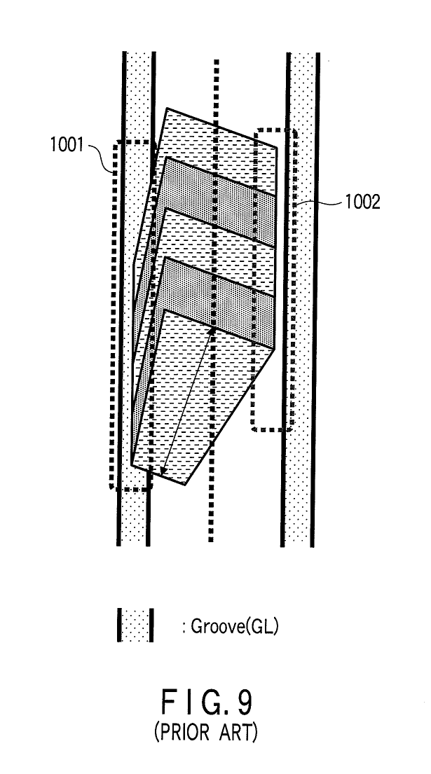

### DETAILED DESCRIPTION

Various embodiments according to the invention will be described hereinafter with reference to the accompanying drawings. In general, according to one embodiment of the invention, there is provided a magnetic disk drive which can enhance signal quality using a patterned medium and a write offset correction method.

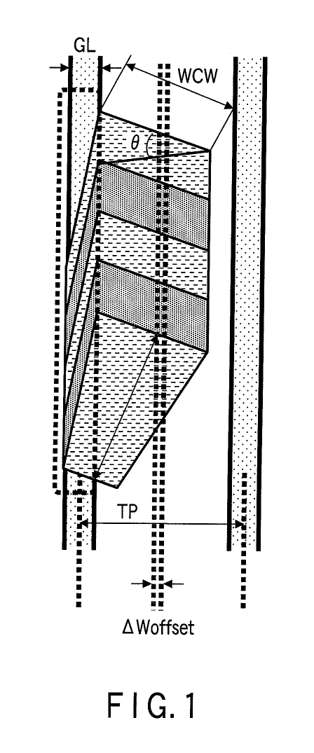

According to the first embodiment, FIG. 1 is a view showing write head offset correction.

Referring to FIG. 1, TP, GL, WCW, and θ respectively represent a track pitch, a groove width (or the average width of grooves on the two sides of that data track), a length of the bottom side of a trapezoid of a write head, and a yaw angle (angle the tangential direction of a track makes with the write head).

In FIG. 1, letting X be an interval from the head right edge to the left edge of a right groove, we have:

X+2GL+WCW+·cos θ=TP+GL (1)

From equation (1), x=TP−GL−WCW·cos θ.

By dividing this value X by 2, an offset ΔWoffset is calculated by:

ΔWoffset=(TP−GL−WCW·cos θ)/2 (2)

Then, by offsetting the center position of the write head by that offset ΔWoffset in a direction to which the write head tilts its top edge (for example, the left side in FIG. 1), an edge position on a side to which the write head is allowed to protrude can be adjusted to an edge that contacts the neighboring data track in a groove on the side to which the write head tilts its top edge.

In this way, the side to which the write head is allowed to protrude can fall within or substantially fall within a groove having no recording layer, thus enhancing the data quality of data in a data track.

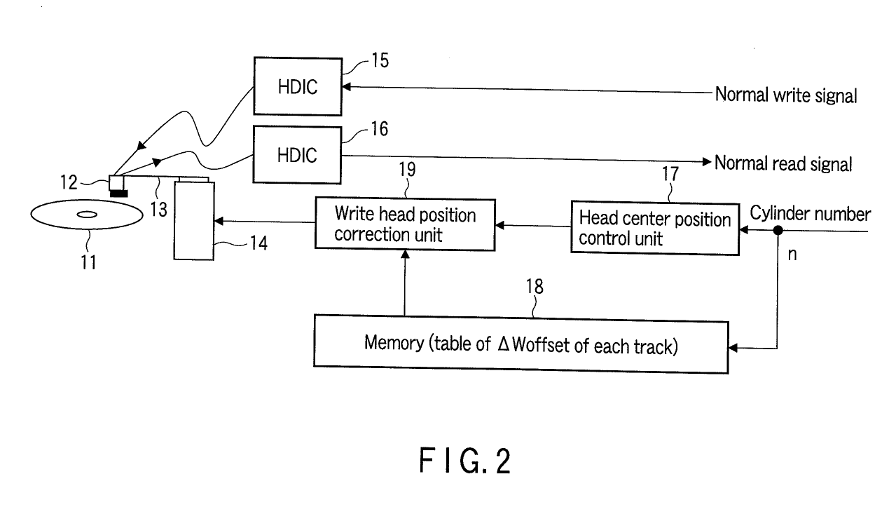

FIG. 2 is a block diagram showing the arrangement of the magnetic disk drive according to the first embodiment.

Referring to FIG. 2, the magnetic disk drive is configured by a disk 11, head unit 12, arm 13, arm moving mechanism 14, head ICs (to be also referred to as “HDICs” hereinafter) 15 and 16, head center position control unit 17, memory 18, and write head position correction unit 19.

The disk 11 is a patterned medium, and data tracks (land portions having a recording layer) and grooves (portions having no recording layer) are alternately arranged in the radial direction of the disk 11, as described above.

The head unit 12 is attached to the distal end of the arm 13, and writes data in a predetermined position on the disk 11 or reads data from a predetermined position in accordance with, e.g., an access instruction (write or read request).

The HDIC 15 is an IC which drives a write head (not shown) in the head unit 12 to write a write signal (user data) on the disk 11.

The HDIC 16 is an IC which drives a read head (not shown) in the head unit 12 to read a read signal (user data or servo data) from the disk 11.

The memory 18 stores an offset (ΔWoffset) calculated for each track (cylinder) number by the method shown in FIG. 1.

The operation of the magnetic disk drive shown in FIG. 2 will be described below.

Servo data (track [cylinder] number and a deviation of the track center of that sector from the current position) of a sector slightly ahead of the current sector on the current track read by the HDIC 16 are output to the head center position control unit 17 and the memory 18.

The head center control unit 17 outputs the deviation in the servo data as a first offset to the write head position correction unit 19.

The write head position correction unit 19 inputs an offset (ΔWoffset) corresponding to the track number in the servo data as a second offset from the memory 18.

The write head position correction unit 19 adds the first and second offsets to calculate the sum as a final offset with respect to the write head.

Note that, for example, a direction from the inner side to the outer side of the disk is defined as a positive direction, an offset indicating an offset in that direction is assigned a “+” sign, and an offset indicating an offset in a direction opposite to that direction is assigned a “−” sign.

According to the first embodiment, the head edge portion on the side to which the top edge of the write head is tilted is recognized as noise. Hence, by setting this head edge portion to fall within or substantially fall within a groove on the side to which the top edge of the write head is tilted, noise can be reduced, and signal quality can be improved.

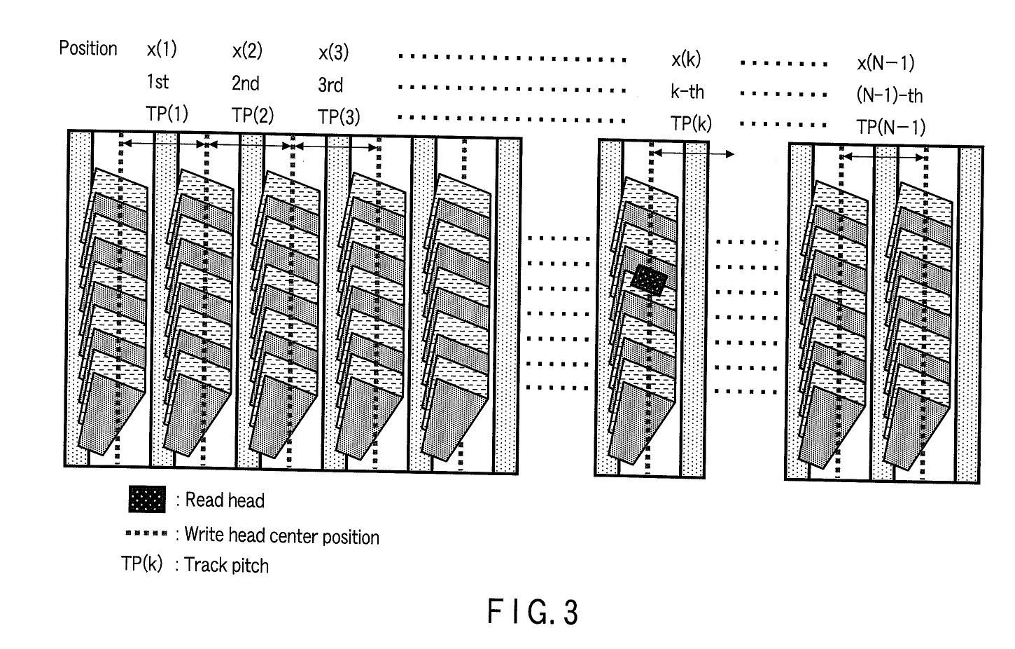

The second embodiment will be described below with reference to FIGS. 3 to 5.

When a write offset position (write head center position) of a target track (for example, the k-th track) with respect to a reference track (for example, the first track) is calculated using a write offset position of the reference track and track pitches between neighboring tracks, a method shown in FIG. 3 is conventionally adopted.

That is, when both the reference track and target track are located on the same side when viewed from a track corresponding to a yaw angle=0°, a write offset position x(k) of the k-th track is calculated by accumulating (adding) a track pitch TP(1) between the first and second tracks, a track pitch TP(2) between the second and third tracks, and a track pitch TP(k−1) between the (k−1)-th and k-th tracks to a write offset position x(1) (an absolute value when the innermost side of the disk in the radial direction is represented by “0” and a direction from the inner side to the outer side is set as a positive direction) of the first track.

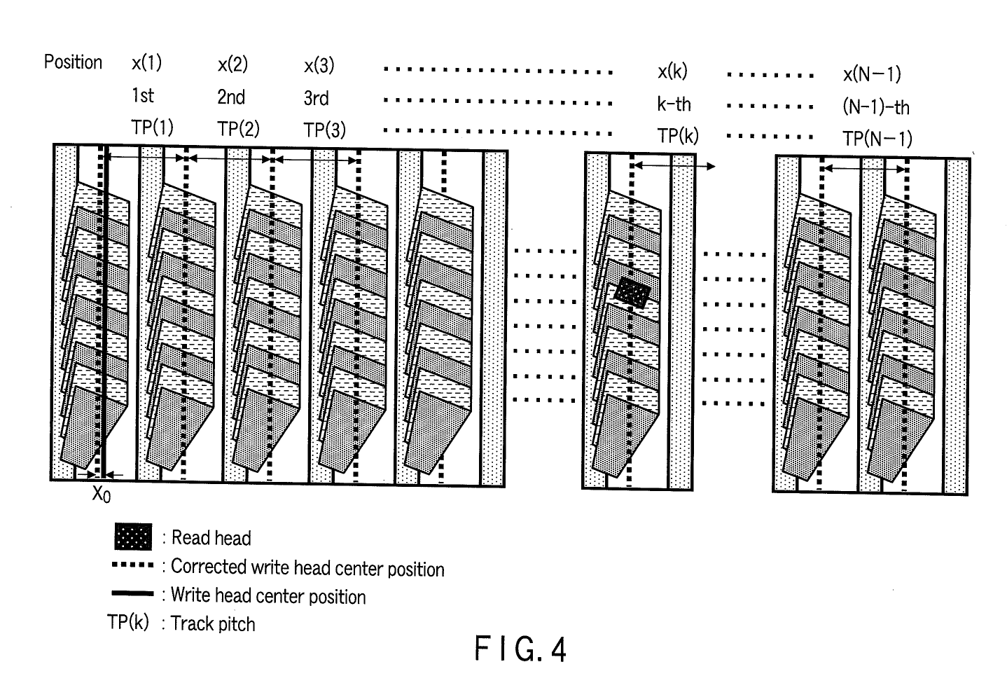

By contrast, in this second embodiment, as shown in FIG. 4, the write offset position of the reference track is offset in a direction to which the top edge of the write head of the reference track is tilted (to the left side in FIG. 4) by an offset (ΔWoffset; it is described as x0 (x0>0) in this case) with respect to the reference track (for example, the first track) calculated by the method shown in FIG. 1. That is, a position x(1)−x0 is set as the write offset position of the reference track.

Then, when both the reference track and target track are located on the same side when viewed from a track corresponding to a yaw angle=0°, the write offset position x(k) of the k-th track is calculated by accumulating (adding) the track pitch TP(1) between the first and second tracks, the track pitch TP(2) between the second and third tracks, and the track pitch TP(k−1) between the (k−1)-th and k-th tracks to the corrected write offset position x(1)−x0 of the first track using:

$$x ( k ) = x ( 1 ) - {x}_{0} + {\sum }_{m = 1}^{k - 1} TP ( m ) \qquad ( 3 )$$

In this way, as shown in FIG. 4, on the reference track, the side to which the write head is allowed to protrude can fall within or substantially fall within a groove having no recording layer.

When both the reference track and target track are located on the same side when viewed from a track corresponding to a yaw angle=0°, since the reference track and target track have the same offset direction (a direction to which the top edge of the write head is tilted), the side to which the write head is allowed to protrude can also fall within or substantially fall within a groove having no recording layer on the target track.

In the second embodiment, since the offset (ΔWoffset) can be calculated for only the reference track, an effect of saving steps of the offset calculation can be provided in addition to that of the first embodiment.

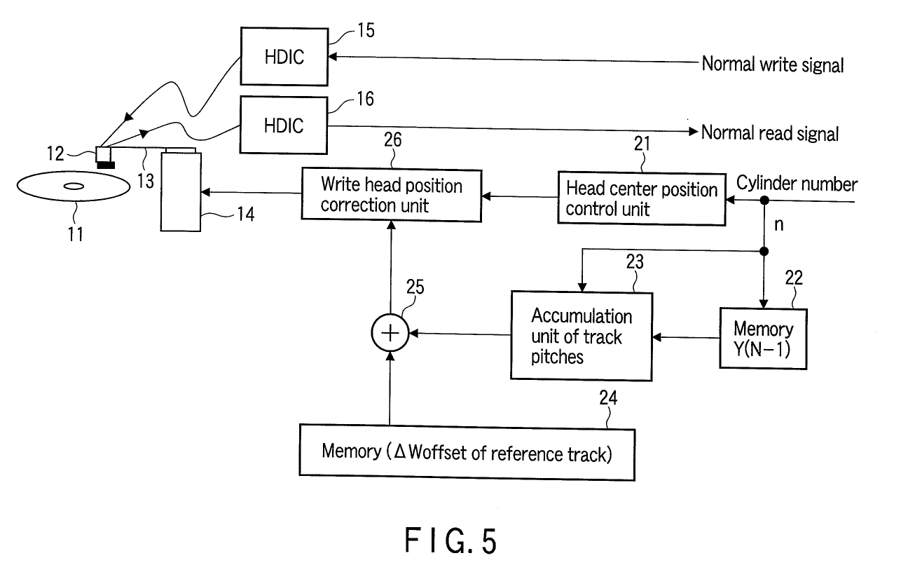

FIG. 5 is a block diagram showing the arrangement of a magnetic disk drive according to the second embodiment.

Referring to FIG. 5, the magnetic disk drive is configured by a disk 11, head unit 12, arm 13, arm moving mechanism 14, head ICs (also referred to as “HDICs” hereinafter) 15 and 16, head center position control unit 21, memory 22, accumulation unit 23, memory 24, adder 25, and write head position correction unit 26.

The disk 11, head unit 12, arm 13, arm moving mechanism 14, and HDICs 15 and 16 are the same as those in FIG. 2, and a description thereof will not be repeated.

The memory 22 stores track pitches Y (Y(k−1)) between neighboring tracks (e.g., the (k−1)-th and k-th tracks).

The memory 24 stores an offset (ΔWoffset) calculated for only the reference track by the method shown in FIG. 1.

The operation of the magnetic disk drive shown in FIG. 5 will be described below.

Servo data (track [cylinder] number n and a deviation of the track center of that sector from the current position) of a sector slightly ahead of the current sector of the current track read by the HDIC 16 are output to the head center position control unit 21, memory 22, and accumulation unit 23.

The head center position control unit 21 outputs the deviation in the servo data as a first offset to the write head position correction unit 26.

The memory 22 holds a track number m of the reference track, and outputs, to the accumulation unit 23, (n−m+1) values of a track pitch Y(m) between the m-th and (m+1)-th tracks, a track pitch Y(m+1) between the (m+1)-th and (m+2)-th tracks, . . . , a track pitch Y(n−1) between the (n−1)-th and n-th tracks with respect to a track number n (for example, n>m) (of the target track) in the input servo data.

The accumulation unit 23 holds a write offset position x(m) with respect to the reference track (m-th track), calculates a sum total of the (n−m+1) track pitch values input from the memory 22 and the write offset position x(m) of the reference track, and outputs the processing result to the adder 25.

The adder 25 inputs the offset (ΔWoffset) corresponding to the reference track as a second offset from the memory 24.

The adder 25 adds the processing result of the accumulation unit 23 to the second offset from the memory 24, and outputs the sum as a write offset position on the target track (n-th track) to the write head position correction unit 26.

The write head position correction unit 26 adds the first offset input from the head center position control unit 21 and the write offset position input from the adder 25 to calculate the sum as a final (corrected) write offset position of the target track (n-th track).

According to the second embodiment, the head edge portion on the side to which the top edge of the write head is tilted is recognized as noise. Hence, by setting this head edge portion to fall within or substantially fall within a groove on the side to which the top edge of the write head is tilted on the reference track, noise on the reference track can be reduced, and signal quality can be improved. When the reference track and target track are located on the same side when viewed from a track with a yaw angle=0°, since they have the same direction to which the write head tilts its top edge, the reference track and target track have the same offset direction used to set the head edge portion to fall within or substantially fall within a groove on the side to which the top edge of the write head is titled. For this reason, on the target track as well, the signal quality can be improved.

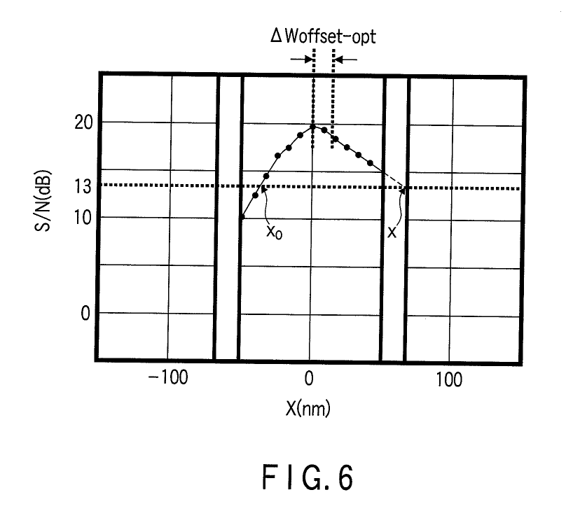

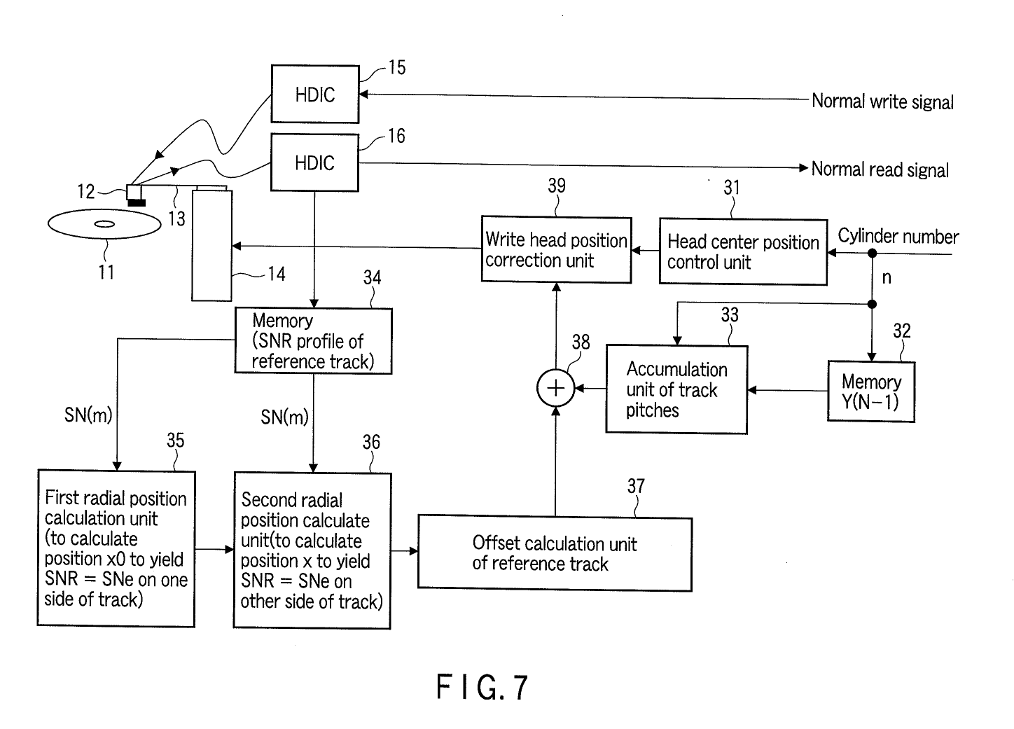

The third embodiment will be described below with reference to FIGS. 6 and 7.

FIG. 6 is a graph showing a track profile of a signal-to-noise ratio (SNR). In FIG. 6, for example, the SNRs of a track corresponding to a yaw angle=20° are indicated by respective radial positions of that track.

When test data is written in a track and is analyzed using, e.g., a measuring device (spectrum analyzer), the SNRs can be calculated at respective radial positions of the track.

When a track which satisfies a desired SNR (13 dB or more in FIG. 6) is to be obtained, the following processing is executed.

A curve (a polygonal line in case of linear interpolation) is generated by interpolating respective measurement points (SN(m), 1≦m≦j, j is the number of measurement points) in FIG. 6. On the side to which the write head tilts its top edge, a radial position x0 where an SNR matches SNe is calculated.

On the other hand, on a side opposite to the side to which the write head tilts its top edge, the curve is extended to a groove region on that side, and a radial position x where an SNR matches SNe is calculated on that side.

Then, by calculating a difference between the track center (x(k) if the current track is the k-th track) of the current track and a midpoint between the calculated points x0 and x, an offset (ΔWoffset−opt) is calculated by:

ΔWoffset−opt=x(k)−(x0−x)/2 (4)

By offsetting the write head to the side to which the top edge of the write head is tilted by this offset (ΔWoffset−opt), a desired SNR can be satisfied on respective points on the track in the radial direction.

For example, this offset ΔWoffset−opt becomes negative in FIG. 6. This means that the offset direction is the left direction on the plane of paper.

FIG. 7 is a block diagram showing the arrangement of a magnetic disk drive according to the third embodiment.

Referring to FIG. 7, the magnetic disk drive is configured by a disk 11, head unit 12, arm 13, arm moving mechanism 14, head ICs (to be also referred to as “HDICs” hereinafter) 15 and 16, head center position control unit 31, memory 32, accumulation unit 33, memory 34, first radial position calculation unit 35, second radial position calculation unit 36, offset calculation unit 37, adder 38, and write head position correction unit 39.

The disk 11, head unit 12, arm 13, arm moving mechanism 14, and HDICs 15 and 16 are the same as those in FIG. 2, and a description thereof will not be repeated.

The memory 32 stores track pitches Y (Y(k−1)) between neighboring tracks (e.g., the (k−1)-th and k-th tracks).

The memory 34 stores respective measurement points (SN(m), 1≦m≦j, j is the number of measurement points) in FIG. 6.

The operation of the magnetic disk drive shown in FIG. 7 will be described below.

Servo data (track [cylinder] number n and a deviation of the track center of that sector from the current position) of a sector slightly ahead of the current sector of the current track read by the HDIC 16 are output to the head center position control unit 31, memory 32, and accumulation unit 33.

At this time, a notification indicating reading of the servo data is output to the memory 34 which stores the SNR profile of the reference track.

The head center position control unit 31 outputs the deviation in the servo data as a first offset to the write head position correction unit 39.

The memory 32 holds a track number m of the reference track, and outputs, to the accumulation unit 33, (n−m+1) values of a track pitch Y(m) between the m-th and (m+1)-th tracks, a track pitch Y(m+1) between the (m+1)-th and (m+2)-th tracks, . . . , a track pitch Y(n−1) between the (n−1)-th and n-th tracks with respect to a track number n (for example, n>m) (of the target track) in the input servo data.

The accumulation unit 33 holds a write offset position x(m) with respect to the reference track (m-th track), calculates a sum total of the (n−m+1) track pitch values input from the memory 32 and the write offset position x(m) of the reference track, and outputs the processing result to the adder 38.

In response to the notification indicating reading of the servo data, the memory 34 outputs, for example, the measurement points (SN(m), 1≦m≦j, j is the number of measurement points) in FIG. 6 to the first radial position calculation unit 35 and the second radial position calculation unit 36.

The first radial position calculation unit 35 holds a threshold SNe of the SNR. Then, the first radial position calculation unit 35 generates a curve by interpolating the measurement points (SN(m)) input from the memory 34, and calculates a radial position x0 on the curve where an SNR of a point on this curve matches the threshold SNe on the side to which the write head tilts its top edge.

The second radial position calculation unit 36 holds the same threshold SNe as in the first radial position calculation unit 35. Then, the second radial position calculation unit 36 generates a curve by interpolating the measurement points (SN(m)) input from the memory 34, extends the curve to a groove region on the side opposite to the side to which the write head tilts its top edge, and calculates a radial position x where an SNR matches the threshold SNe on that side.

The offset calculation unit 37 calculates an offset (ΔWoffset−opt) by calculating a difference between the track center (x(n) if the current track is the n-th track) of the current track and a midpoint between the calculated points x0 and x using:

ΔWoffset−opt=x(n)−(x0−x)/2 (5)

Then, the offset calculation unit 37 outputs this offset (ΔWoffset−opt) as a second offset to the adder 38.

The adder 38 adds the processing result of the accumulation unit 33 to the second offset from the offset calculation unit 37, and outputs the sum as a write offset position on the target track (n-th track) to the write head position correction unit 39.

The write head position correction unit 39 adds the first offset input from the head center position control unit 31 and the write offset position input from the adder 38 to calculate the sum as a final (corrected) write offset position of the target track (n-th track).

According to the third embodiment, when a signal quality criterion is decided as a certain SNR (dB) or more, the write offset position can be decided to satisfy that signal quality criterion.

The fourth embodiment will be described below.

In the third embodiment, the signal quality is expressed by the SNR. However, in the fourth embodiment, the signal quality is expressed by the bit error rate (BER). In the fourth embodiment as well, a BER track profile is generated as in the third embodiment.

That is, when test data is written in a track, and bit error rates are measured at respective positions by shifting a read position in 10-nm increments in the radial direction of that track, a BER track profile is obtained. Note that since the signal quality becomes better with decreasing bit error rate, this profile has a downward convex curve in place of an upward convex curve shown in FIG. 6.

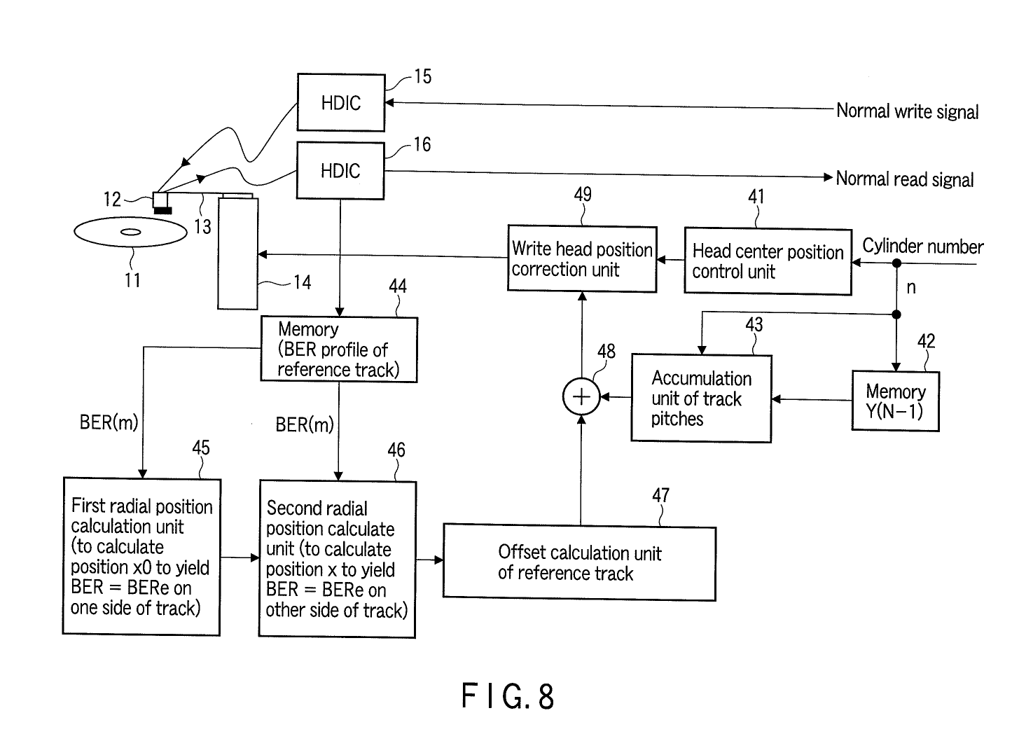

FIG. 8 is a block diagram showing the arrangement of a magnetic disk drive according to the fourth embodiment.

Referring to FIG. 8, the magnetic disk drive is configured by a disk 11, head unit 12, arm 13, arm moving mechanism 14, head ICs (to be also referred to as “HDICs” hereinafter) 15 and 16, head center position control unit 41, memory 42, accumulation unit 43, memory 44, first radial position calculation unit 45, second radial position calculation unit 46, offset calculation unit 47, adder 48, and write head position correction unit 49.

The disk 11, head unit 12, arm 13, arm moving mechanism 14, and HDICs 15 and 16 are the same as those in FIG. 2, and a description thereof will not be repeated.

The memory 42 stores track pitches Y (Y(k−1)) between neighboring tracks (e.g., the (k−1)-th and k-th tracks).

The memory 44 stores measurement points (BER(m), 1≦m≦j, j is the number of measurement points) of a bit error rate.

The operation of the magnetic disk drive shown in FIG. 8 will be described below.

Servo data (track [cylinder] number n and a deviation of the track center of that sector from the current position) of a sector slightly ahead of the current sector of the current track read by the HDIC 16 are output to the head center position control unit 41, memory 42, and accumulation unit 43.

At this time, a notification indicating reading of the servo data is output to the memory 44 which stores the BER profile of the reference track.

The head center position control unit 41 outputs the deviation in the servo data as a first offset to the write head position correction unit 49.

The memory 42 holds a track number m of the reference track, and outputs, to the accumulation unit 43, (n−m+1) values of a track pitch Y(m) between the m-th and (m+1)-th tracks, a track pitch Y(m+1) between the (m+1)-th and (m+2)-th tracks, . . . , a track pitch Y(n−1) between the (n−1)-th and n-th tracks with respect to a track number n (for example, n>m) (of the target track) in the input servo data.

The accumulation unit 43 holds a write offset position x(m) with respect to the reference track (m-th track), calculates a sum total of the (n−m+1) track pitch values input from the memory 42 and the write offset position x(m) of the reference track, and outputs the processing result to the adder 48.

In response to the notification indicating reading of the servo data, the memory 44 outputs the measurement points (BER(m), 1≦m≦j, j is the number of measurement points) to the first radial position calculation unit 45 and the second radial position calculation unit 46.

The first radial position calculation unit 45 holds a BER threshold BERe. Then, the first radial position calculation unit 45 generates a curve by interpolating the measurement points (BER(m)) input from the memory 44, and calculates a radial position x0 on the curve where the BER ratio of a point on this curve matches the threshold BERe on the side to which the write head tilts its top edge.

The second radial position calculation unit 46 holds the same threshold BERe as in the first radial position calculation unit 45. Then, the second radial position calculation unit 46 generates a curve by interpolating the measurement points (BER(m)) input from the memory 44, extends the curve to a groove region on the side opposite to the side to which the write head tilts its top edge, and calculates a radial position x where the BER matches the threshold BERe on that side.

The offset calculation unit 47 calculates an offset (ΔWoffset−opt) by calculating a difference between the track center (x(n) if the current track is the n-th track) of the current track and a midpoint between the calculated points x0 and x using:

ΔWoffset−opt=x(n)−(x0−x)/2 (6)

Then, the offset calculation unit 47 outputs this offset (ΔWoffset−opt) as a second offset to the adder 48.

The adder 48 adds the processing result of the accumulation unit 43 to the second offset from the offset calculation unit 47, and outputs the sum as a write offset position on the target track (n-th track) to the write head position correction unit 49.

The write head position correction unit 49 adds the first offset input from the head center position control unit 41 and the write offset position input from the adder 48 to calculate the sum as a final (corrected) write offset position of the target track (n-th track).

According to the fourth embodiment, when a signal quality criterion is decided as once or less per the predetermined number of times in a bit error rate (BER), the write offset position can be decided to satisfy that signal quality criterion.

In the above description, the third and fourth embodiments are premised on the arrangement of the second embodiment, but they may be premised on that of the first embodiment. In this case, the offset which satisfies the signal quality criterion (SNR or BER) is calculated for each track.

In the above description, in the third and fourth embodiments, measurement points where signal qualities (SNRs or BERs) measured on both the sides of a track match the signal quality threshold are calculated, and an offset is decided by calculating a difference between their average and the track center position. However, a position which is offset from the track center of the target track to the side to which the write head tilts its top edge by a predetermined distance is stored in advance, and an offset may be decided so that a measurement point (on the side to which the top edge is tilted), at which the signal quality (SNR or BER) measured at each radial position of a track matches the signal quality threshold, matches the position offset from the track center by the predetermined distance.

It is preferable that when the respective units which execute servo control in the respective embodiments of the present invention are arranged on the same printed circuit board as a signal processing system of a recording/reproduction circuit, the signal quality can be improved.

On the other hand, it is more preferable that when the respective units which execute the servo control in the respective embodiments of the present invention are configured by an integrated circuit, the signal quality can be further improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk drive comprising:
a disk comprising a patterned medium, the patterned medium comprising grooves and data tracks comprising a recording layer;
an adjustment module configured to adjust a head center position of a write head in such a manner that a head edge portion on a side to which a top edge of the write head is tilted upon changing a yaw angle falls within a groove on the side to which the top edge of the write head is tilted; and
a write head position controller configured to control a write head position based on the adjustment.

2. The magnetic disk drive of claim 1, wherein the adjustment module is configured to adjust the head edge portion substantially within the groove on the side to which the top edge is tilted by offsetting the head center position of the write head to the side to which the write head tilts the top edge by the halved value of the subtraction result by subtracting a value obtained by multiplying a write core width by a cosine of the yaw angle from a difference between a track pitch and a groove width.

3. The magnetic disk drive of claim 1, wherein the adjustment module is configured to adjust the head edge portion substantially within the groove on the side to which the top edge is tilted by offsetting the head center position of the write head to the side to which the write head tilts the top edge in such a manner that signal to noise ratios at respective radial positions of a track measured in advance are equal or greater than a threshold of a signal to noise ratio at a track edge on the side to which the write head tilts the top edge.

4. The magnetic disk drive of claim 1, wherein the adjustment module is configured to adjust the head edge portion substantially within the groove on the side to which the top edge is tilted by offsetting the head center position of the write head to the side to which the write head tilts the top edge in such a manner that error rates at respective radial positions of a track measured in advance are equal to or less than a threshold of an error rate at a track edge on the side to which the write head tilts the top edge.

5. A magnetic disk drive comprising:
a disk comprising a patterned medium, the patterned medium comprising grooves and data tracks comprising a recording layer;
an offset storage module configured to store an offset used for setting a head edge portion on a side to which a top edge of a write head is tilted substantially within a groove on the side to which the top edge of the write head is tilted on a reference track;
an adjustment module configured to calculate a write offset position of a current track by accumulating track pitches between neighboring tracks from the reference track to the current track to a write offset position of the reference track to which the offset is added; and
a write head position controller configured to control a write head position based on the adjustment.

6. The magnetic disk drive of claim 5, wherein the offset is calculated by calculating a difference between a track pitch and a groove width, subtracting a value obtained by multiplying a write core width by a cosine of a yaw angle from the difference, and halving the subtraction result.

7. The magnetic disk drive of claim 5, wherein the offset is determined in such a manner that signal to noise ratios at respective radial positions of a track measured in advance are equal to or more than a threshold of a signal to noise ratio at an edge of the reference track on the side to which the write head tilts the top edge.

8. The magnetic disk drive of claim 5, wherein the offset is determined in such a manner that error rates at respective radial positions of a track which are measured in advance become not more than a threshold of the error rate at an edge of the reference track on the side to which the write head tilts the top edge.

9. The magnetic disk drive of claim 1, wherein the adjustment module and the write head position controller are on the same printed circuit board as a signal processing circuit of a recording/reproduction circuit.

10. The magnetic disk drive of claim 1, wherein the adjustment module and the write head position controller are in an integrated circuit.

11. A write offset correction method of controlling a write head position in a magnetic disk drive comprising a disk comprising a patterned medium comprising grooves and data tracks comprising a recording layer, the method comprising:
adjusting a head center position of a write head in such a manner that a head edge portion on a side to which a top edge of the write head is tilted upon changing a yaw angle as an angle a tangential direction of the disk in order to adjust the write head substantially within a groove on the side to which the top edge of the write head is tilted; and
controlling the write head position based on the adjustment.

12. A write offset correction method of controlling a write head position in a magnetic disk drive comprising a disk comprising a patterned medium comprising data tracks comprising grooves and a recording layer, the method comprising:
calculating a write offset position of a current track by accumulating track pitches between neighboring tracks from a reference track to the current track to a write offset position of the reference track to which an offset used for set a head edge portion on a side to which a top edge of a write head is tilted substantially within a groove on the side to which the top edge of the write head is tilted on the reference track is added; and
controlling a write head position based on the calculation.
